(19) United States
(12) Patent Application Publication
(10) Pub. No.: US 2003/0067777 A1
(43) Pub. Date: Apr. 10, 2003

(54) Structure design for lampshade assembly

(76) Inventor: Mei-Ju Juang, Shulin City (TW)

Correspondence Address: BACON & THOMAS, PLLC, 625 SLATERS LANE, FOURTH FLOOR, ALEXANDRIA, VA, 22314

(21) Appl. No.: 09/973,085

(22) Filed: Oct. 10, 2001

(51) Int. Cl. F21V 11/00

(52) U.S. Cl. 362/351; 362/361

(57) ABSTRACT

The present invention is “an improved structure design for lampshade assembly” including a frame, several covers and few individual parts. The cover is in an arc shape structured by metal frame along the edge, which is wrapped with paper or fabric. The frame contains three crimp con rods in a triangular shape. The characteristics are that each individual cover contains two locks which situates on both top and bottom end at one side of the cover. Each of the locks contains a “C” shape notch which allow the metal stick to be embedded in. There is a joint attached to the notch, the joint is cleaved the metal stick, hence to allow assembling and demounting covers more effectively and efficiently.

### BACKGROUND OF THE INVENTION

The present invention relates to an improved structure design for lampshade assembly. The present lampshade is constructed by a frame body together with several covers. The characteristic of the present invention includes the following: two locks situated on one side of each individual cover, this design enabled covers to be cleaved to each other, in order to form a round-shape lampshade. A frame is then added to the top end of the completed lampshade, in order to consolidate the structure of the lampshade. Hence to form a vacant lampshade which allows lamps to be placed within.

In addition, these individual covers can be reassembling after demounted. As there will only be few individual portions after lampshade been demounted, the present invention takes the effect of compressing the volume of the lampshade. Therefore the present invention is able to make storage and transportation of lampshades more effective, hence gain a maximum benefit of saving spaces.

### SUMMARY OF THE INVENTION

The present invention relates to the design of lampshade structure. In particular, the present enable user an easy assembly, also makes storage and transportation of lampshades more effective, hence to cut down the overheads of lampshade making.

There are various types of the conventional lamps. In particular with the lampshade, although there is a wide range of lampshade to choose from, the design of lampshade structure is not applicable. The defects are as followed:

1. A conventional body structure of lampshade is either made in one portion, or welded as a whole. Users will have to buy the whole lamp again if they wish to change or swap those lampshades. Which will not be economic cost-effective.

2. As mentioned above, there could be a wide range of different type of lampshades. The actual body structure of these lampshades would be very similar to each other, hence not innovative. Although these type lampshades could be stable and strong enough, they will be not able to be replaced, moved or changed since they were welded when they were made. It would be a waste, as these lampshades will be damaged if they would be changed, moved or changed by users.

3. Conventional lamps are fixed with the lampshade and materials outside the surface of the lampshade. These lamps usually contain a larger body volume, and take more space when either storing or transporting, even after positioning. Furthermore, due to the space taking by these conventional lumps when transporting, the number of these lumps to be transport each time are limited and often small, hence to incurred a higher over-heads cost of lampshade making.

Accordingly, the present inventor took these defects into consideration; by taking these thought combined together with accumulated years working experiences and special background knowledge, to form the present invention—“an improved structure design for lampshade assembly” to the general public. The characteristic of present invention is to replace the conventional body structure of the lampshade with an easy reassembly setting. This design will eliminate the above-mentioned defects without affecting the stability of the lamps.

As an overall conclusion, the main purpose of the present invention is to invite an improved structure design for lampshade assembly. This design will offer users an easy assembly and demountable body-structure for lampshades, also makes storage and transporting of lampshades more efficiently and effectively. In addition, although there are only few individual portions to the unit, the stability will not be affected. Therefore, the present invention is suitable to be manufactured in a large quantity, due to the fact of easy stored and transported, as this design enable a large space saving soon after it is demounted.

The beneficial points of the present invention are as follow:

1. The structure of the present invention—“an improved structure design for lampshade assembly”, is constructed with several individual covers, each individual cover can be replaced according to users' needs.

2. The appearance of the present invention—“an improved structure design for lampshade assembly”, these covers are changeable in preference to users. Which offers an economic consumption to users.

3. The assembly of the present invention—“an improved structure design for lampshade assembly”, offers an easy assembles setting, allow storage and transporting of lampshades more efficiently and effectively, hence to save a greater space.

### BRIEF DESCRIPTION OF THE DRAWINGS

FIG. 1 is a demounted view of the present invention.

FIG. 2 is an assembly view of the present invention.

FIG. 3 is a semi-interactive view of the present invention.

FIG. 4 is a semi-structure view of the present invention.

FIG. 5 is an applicative view of the present invention.

### DETAILED DESCRIPTION OF THE PREFERRED EMBODIMENT

Cover (1) Metal stick (101)

Binder (102) Binding hole (103)

Lock (10) Notch (11)

Joint (12) Chimaeric portion (13)

Frame (2) Con rod (20)

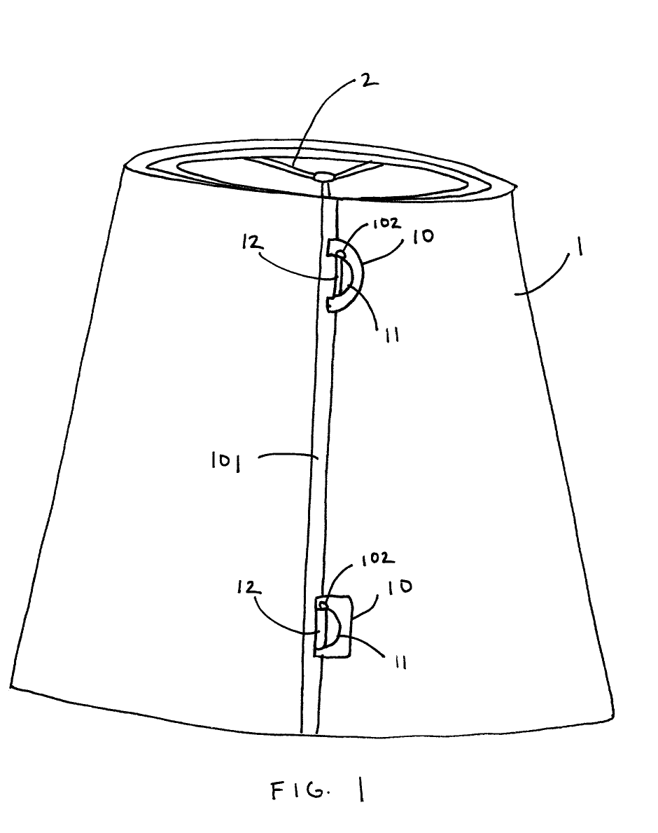

As refer to FIGS. 1 & 2—demounted view and assembly view of the present invention. The lampshade is constructed by several covers (1) and a frame (2). The covers (1) is structured by metal stick (101) alone the edge, which is wrap with paper or fabric. The purpose is to stop lighting spreading out, hence to concentrate the lighting effect. All of the covers (1) are in arc fan shape. Two locks (10) situates on both top and bottom end at one side of the cover (1). Each of the lock (10) contains a “C” shape notch (11) that allows the metal stick (101) to embed in. There is a joint (12) attached to the notch (11), the joint (12) is cleaved with the flat area on the metal stick (101), the binder (102) protrudes on one end of the joint (12). The design allowed the lock (10) to be turning around by the axis—the joint (12).

Blank

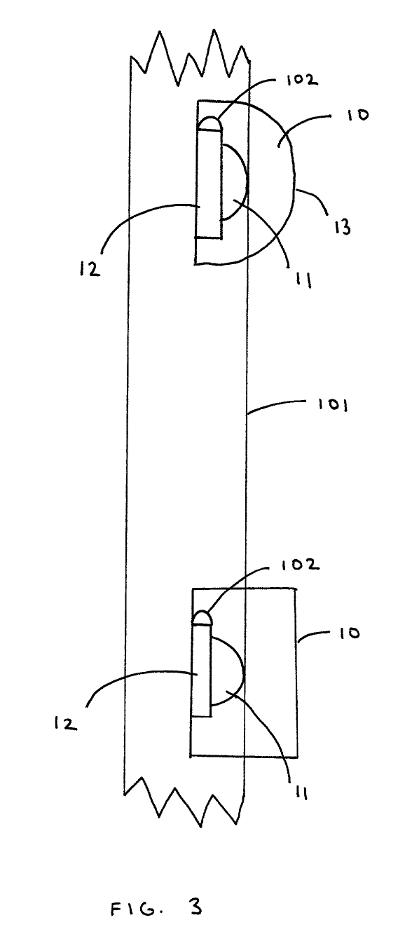

As refer to FIG. 3, the lock (10) situates on the top end of the cover (1), has the design of “C” shape chimaeric portion (13), and the lock (10) situates on the bottom end of the cover, has not got the design of “C” shape chimaeric portion (13).

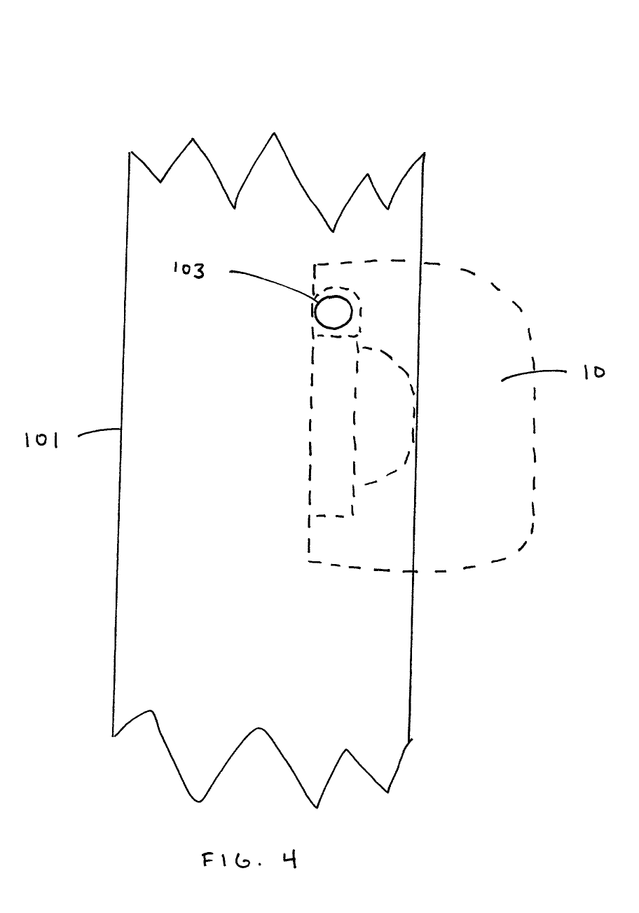

The lock (10) is made from plastic or rubber, which enable a closer cleave between covers (1). Refer to FIG. 4, the metal stick (101) is attached to the lock (10), which has a flat area where the binding hole (103) is. When two covers (1) attach to each other, the design allow the binder (102) embedded into the binding hole (103), hence accomplish a perfect fit to covers (1).

The frame (2), contain three crimp con rod (20) in a triangular shape. The con rod (20) is then embedded to the chimaeric portion (13), which stabilized the lock (10) and covers (1).

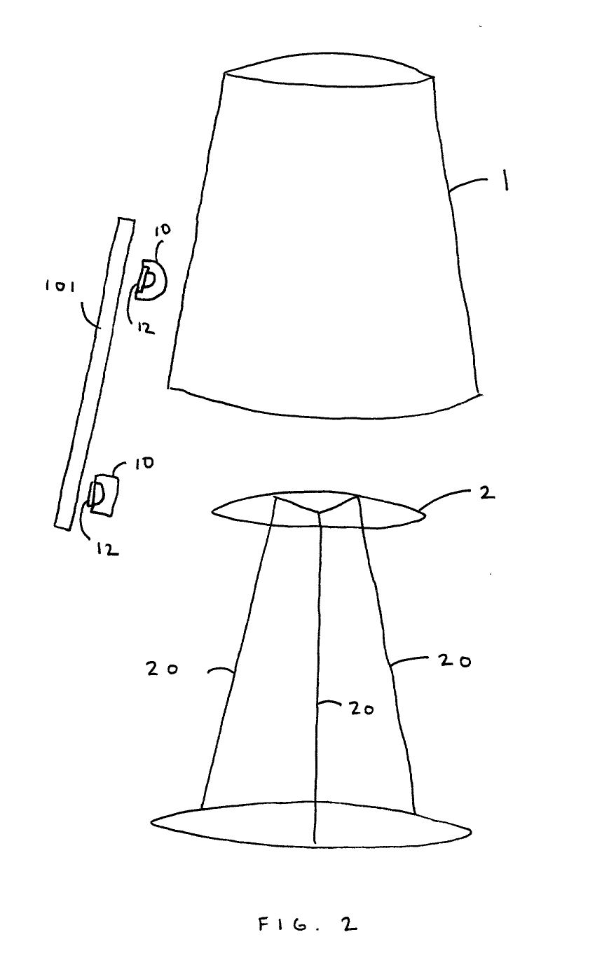

As mentioned above, the present invention—“an improved structure design for lampshade assembly”, formed by coping covers together, and locked by the lock (10) and metal stick (101) on the side covers (1), which enable a closer cleave between covers (1), repeating the same instruction till all the covers locked together to form a lampshade. Then fix the frame to the top end of the lampshade, by embedded three crimp con rods (20) into the chimaeric portion (13) on the lock (10). Therefore to give a maximum stability of the lampshade as refer to FIG. 2.

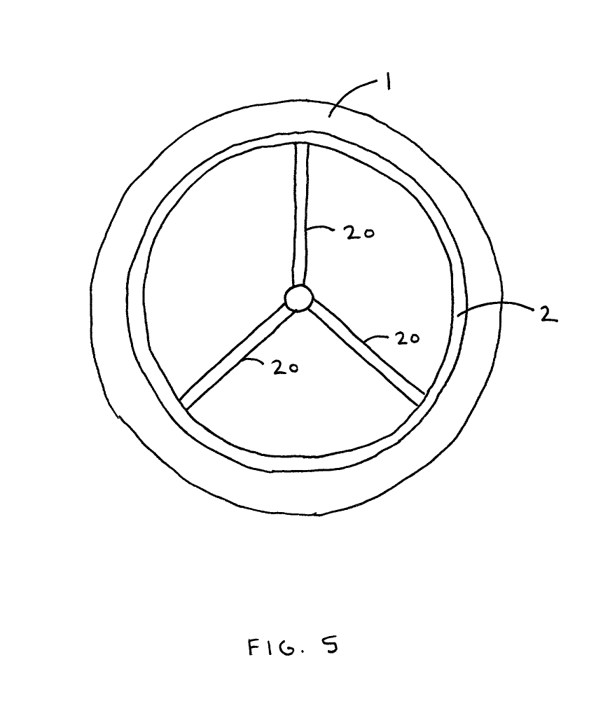

Refer to FIG. 5, an applicative view of the present invention, for each cover (1) and frame (2) are different individuals. They can be demounted when the lampshade is not in use, easy to pack, hence to meet the criteria of space saving. Especially, when these types of lampshades are manufactured in a large quantity, they can be stored and transported in a more effective and efficient way.

Accordingly, the improvement of present invention—“an improved structure design for lampshade assembly”, meet the expected purpose design, for which never been seem or disclosed in the same product types. Since the present invention fits the requirement of utility model patent, we shall be much grateful if the present invention can be verified and granted in the early period.

What is claimed:

1. The present invention is “an improved structure design for lampshade assembly”, includes a frame, several covers and few individual parts. The cover is in an arc shape structured by metal frame alone the edge, which is wrap with paper or fabric. The frame contains three crimp con rods in a triangular shape. The characteristics are as follow:
Each individual cover contains two locks, which situates on both top and bottom end at one side of the cover. Each of the lock contains a “C” shape notch, which allow the metal stick to be embedded in. There is a joint attached to the notch, the joint is cleaved to the metal stick, hence to allow assembling and demounting covers more effectively and efficient.

2. The present invention is “an improved structure design for lampshade assembly” as claimed in claim 1, the lock that situated on the lampshade, contains a chimaeric portion in “C” shape.

3. The present invention is “an improved structure design for lampshade assembly” as claimed in claim 1, a binder protrudes at where the joint and metal stick attached.
